(19) United States
(12) Patent Application Publication
(10) Pub. No.: US 2005/0005249 A1
(43) Pub. Date: Jan. 6, 2005

(54) Combined content selection and display user interface

(75) Inventors: Brian T. Hill, Renton, WA (US); Jesse Clay Satterfield, Seattle, WA (US); Jensen M. Harris, Kirkland, WA (US); Hans J. Bjordahl, Seattle, WA (US); Martijn E. Van Tilburg, Seattle, WA (US); Jason Vincent Morse, Bellevue, WA (US); U Chi Chiang, San Jose, CA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/836,154

(22) Filed: Apr. 30, 2004

Related U.S. Application Data
(60) Provisional application No. 60/484,437, filed on Jul. 1, 2003.

(51) Int. Cl. G09G 5/00

(52) U.S. Cl. 715/963; 715/810

(57) ABSTRACT

A combined content selection and content display user interface or pane is provided. A lower portion of the combined content selection and display pane includes one or more selectable buttons or icons corresponding to one or more program modules of a multiple functionality software application. An upper portion of the combined content selection and display pane includes selectable buttons or icons specific to one program module selected from the lower portion of the content selection and display pane. Selection of a given program module button or icon from the lower portion of the pane causes a display in the upper portion of the pane of one or more selectable buttons or icons associated with the selected program module. The one or more selectable buttons or icons displayed in the upper portion allow a user to select functionality and memory locations specific to the selected program module.

### CROSS REFERENCE TO RELATED APPLICATIONS

The present application claims priority from U.S. provisional application No. 60/484,437, entitled “Combined Outlook Bar and Folder List, Automatic Grouping, Adaptive Multi-Line View, Threaded View with Easier Access to All New Email, Search Folders,” filed Jul. 1, 2003.

### FIELD OF THE INVENTION

The present invention generally relates to computer-generated graphical user interfaces. More particularly, the present invention relates to an improved combined content selection and display user interface or pane.

### BACKGROUND OF THE INVENTION

With the advent of the computer age, computer and software users have grown accustomed to user-friendly software applications that help them write, calculate, organize, prepare presentations, send and receive electronic mail, make music, and the like. Modem electronic calendar systems allow users to plan their schedules, set meeting dates and track and schedule appointments. Modem contacts programs allow users to store, sort, recall and print contact information. Modem electronic mail programs allow users to send and receive electronic mail to and from other users. Other programs allow users to create task lists and notes.

Systems have been developed that include multiple types of functionality, such as that described above, in a single application so that a user may, for example, maintain her electronic calendar, maintain her electronic contacts, utilize electronic mail, and prepare task lists and notes using a single software application. An example of such a software application is OUTLOOK® manufactured by Microsoft Corporation. For such multiple functionality applications, a user typically may navigate from one type of functionality (e.g., calendar) to another type of functionality (e.g., electronic mail) by selection of one or more buttons or icons.

Such prior systems often provide a first pane or bar containing buttons for selection of each type of available functionality and a second pane containing a display, for example a tree view list, of all individual functionality types and subtypes and all user folders and memory locations for all possible functionality selectable by the user. For example, a tree view structure might contain all functionality under an electronic mail system such as inboxes, sent items, deleted items, as well as, all functionality under a calendar system, a contacts system, and so on. Navigation through such a list of all available functionality and memory locations associated with each available program module of the multiple functionality system is cumbersome and inefficient because the user is forced to navigate or peruse through functionality and memory location icons or buttons not associated with the specific functionality of interest to the user. For example, if the user is only interested in navigating or perusing through the functionality or memory locations buttons or icons of her electronic calendaring program, it is inefficient and cumbersome to force the user to navigate or peruse the buttons or icons associated with her electronic mail or contacts programs. Additionally, such user interface systems and layouts needlessly consume excessive computer display space.

There is a need for an improved computer program user interface that provides a more efficient and user-friendly content selection and display user interface or pane. It is with respect to these and other considerations that the present invention has been made.

### SUMMARY OF THE INVENTION

Embodiments of the present invention solve the above and other problems by providing a combined content selection and content display user interface or pane. A lower portion of the combined content selection and display pane includes one or more selectable buttons or icons corresponding to one or more program modules of a multiple functionality software application. An upper portion of the combined content selection and display pane includes selectable buttons or icons specific to one program module selected from the lower portion of the content selection and display pane.

Selection of a given program module button or icon from the lower portion of the pane causes a display in the upper portion of the pane of one or more selectable buttons or icons associated with the selected program module. The one or more selectable buttons or icons displayed in the upper portion allow a user to select functionality and memory locations specific to the selected program module. A given selected functionality button from the lower portion of the combined content selection and display pane may be color coded or otherwise highlighted to alert a user of the selected program module.

According to aspects of the invention, selection of an electronic mail module button or icon from the lower portion of the content selection and display pane causes display in the upper portion of the pane of selectable buttons or icons such as inbox, sent items, deleted items, drafts, a variety of mail folders, and the like associated with the electronic mail module functionality. Selection of an electronic calendar module button or icon from the lower portion of the pane causes display in the upper portion of the pane of selectable buttons or icons such as a date picker user interface, and a variety of selectable calendars associated with the selected electronic calendar module. Selection of an electronic contacts module button or icon from the lower portion of the pane causes display in the upper portion of the pane selectable buttons or icons associated with contacts program functionality. Selection of a tasks module button or icon from the lower portion of the combined content selection and display pane causes display in the upper portion of the pane of one or more selectable buttons or icons associated with tasks functionality. Selection of a notes module button or icon from the lower portion of the pane causes display in the upper portion of the pane of one or more selectable buttons or icons associated with notes functionality. Selection of a journal button or icon from the lower portion of the pane causes display in the upper portion of the pane of one or more selectable buttons or icons associated with journal functionality. Selection of a shortcuts module button or icon from the lower portion of the pane causes display in the upper portion of the pane of one or more selectable buttons or icons associated with shortcuts functionality.

According to another aspect of the invention, a folder list button or icon may be selected from the lower portion of the combined content selection and display pane for causing a display in the upper portion of the pane of selectable buttons and icons for all functionality available from the multiple functionality application as if all program module or icons are simultaneously selected from the lower portion of the pane. All displayed selectable buttons and icons displayed in the upper portion may be displayed in a tree view structure in alphabetical order.

According to another aspect of the invention, a splitter bar is disposed between the upper and lower portions of the combined content selection and display pane. Dragging the splitter bar upward increases the size of the lower portion of the pane and allows space for disposition of more program module buttons in the lower portion of the pane. Dragging the splitter bar downward decreases the size of the lower portion of the combined content selection and display pane and reduces space for disposition of program module buttons. As space in the lower portion of the combined content selection and display pane is reduced to the extent that a given program module button will no longer fit within the space allocated for the lower portion of the pane, a selectable icon representing the given program module may be displayed in a function bar or tray disposed along the bottom of the lower portion of the pane. According to an aspect of the invention, a chevron or other selectable icon may be disposed in the function bar or tray for causing the display of other program module buttons that are hidden from view in the lower portion of the combined content selection and display pane.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary operating environment for embodiments of the present invention.

FIG. 2 illustrates a computer screen display of a prior content selection pane and a content display pane.

FIG. 3 illustrates a computer screen display of a combined content selection and display pane according to embodiments of the present invention.

FIG. 4 illustrates a computer screen display of a lower portion of a content selection and display pane according to embodiments of the present invention.

FIG. 5 illustrates a computer screen display of a combined content selection and display pane showing display of electronic mail functionality in an upper portion of the pane.

FIG. 6 illustrates a computer screen display showing display of electronic calendar functionality in an upper portion of the combined content selection and display pane.

FIG. 7 illustrates a computer screen display showing electronic contacts program functionality displayed in the upper portion of the combined content selection and display pane.

FIG. 8 illustrates a computer screen display showing shortcuts functionality displayed in the upper portion of the combined content selection and display pane.

FIG. 9 illustrates a computer screen display showing electronic tasks program functionality in the upper portion of the combined content selection and display pane.

FIG. 10 illustrates a computer screen display showing electronic notes program functionality displayed in the upper portion of the combined content selection and display pane.

FIG. 11 illustrates a computer screen display showing electronic journal program functionality displayed in the upper portion of the content selection and display pane.

FIG. 12 illustrates a computer screen display showing a folder list for displaying all functionality in the upper portion of the combined content selection and display pane associated with all program modules of an associated multiple functionality application.

FIG. 13 illustrates a computer screen display of a multiple functionality software application user interface showing a combined content display and selection pane according to embodiments of the present invention.

### DETAILED DESCRIPTION OF THE PREFERRED EMBODIMENT

As briefly described above, embodiments of the present invention are directed to a combined content selection and display user interface or pane with which a user may select a desired program module or functionality available from a multiple functionality software application, and in response to the user's selection, selectable buttons and icons for selecting functionality and memory locations associated with the selected program module or functionality are displayed to the user. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

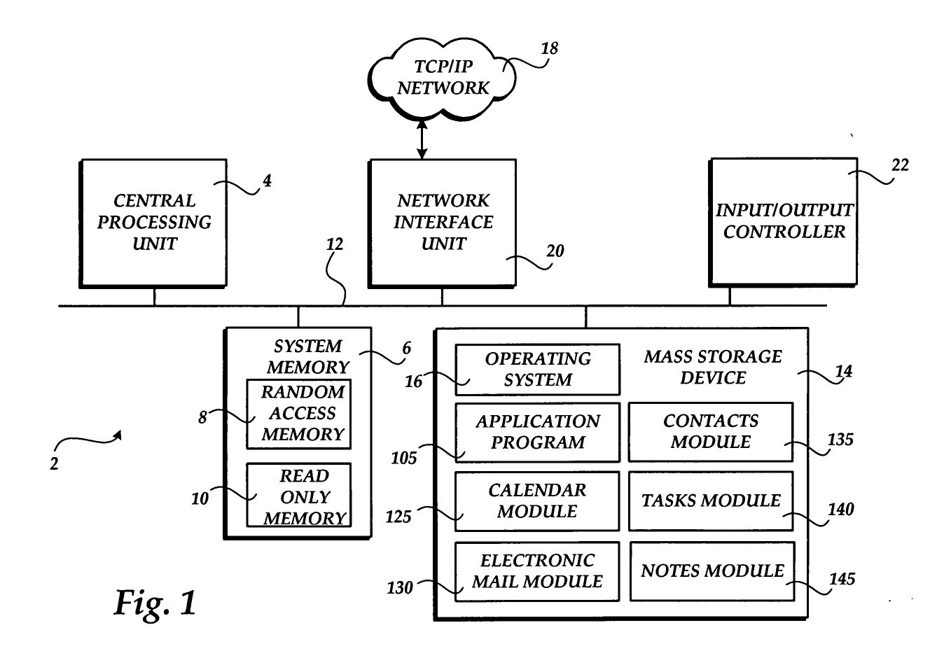

Referring now to the drawings, in which like numerals represent like elements through the several figures, aspects of the present invention and the exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Turning now to FIG. 1, an illustrative computer architecture for a personal computer 2 for practicing the various embodiments of the invention will be described. The computer architecture shown in FIG. 1 illustrates a conventional personal computer, including a central processing unit 4 (“CPU”), a system memory 6, including a random access memory 8 (“RAM”) and a read-only memory (“ROM”) 10, and a system bus 12 that couples the memory to the CPU 4. A basic input/output system containing the basic routines that help to transfer information between elements within the computer, such as during startup, is stored in the ROM 10. The personal computer 2 further includes a mass storage device 14 for storing an operating system 16, application programs, such as the application program 205, and data.

The mass storage device 14 is connected to the CPU 4 through a mass storage controller (not shown) connected to the bus 12. The mass storage device 14 and its associated computer-readable media, provide non-volatile storage for the personal computer 2. Although the description of computer-readable media contained herein refers to a mass storage device, such as a hard disk or CD-ROM drive, it should be appreciated by those skilled in the art that computer-readable media can be any available media that can be accessed by the personal computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the personal computer 2 may operate in a networked environment using logical connections to remote computers through a TCP/IP network 18, such as the Internet. The personal computer 2 may connect to the TCP/IP network 18 through a network interface unit 20 connected to the bus 12. It should be appreciated that the network interface unit 20 may also be utilized to connect to other types of networks and remote computer systems. The personal computer 2 may also include an input/output controller 22 for receiving and processing input from a number of devices, including a keyboard or mouse (not shown). Similarly, an input/output controller 22 may provide output to a display screen, a printer, or other type of output device.

As mentioned briefly above, a number of program modules and data files may be stored in the mass storage device 14 and RAM 8 of the personal computer 2, including an operating system 16 suitable for controlling the operation of a networked personal computer, such as the WINDOWS operating systems from Microsoft Corporation of Redmond, Wash. The mass storage device 14 and RAM 8 may also store one or more application programs. In particular, the mass storage device 14 and RAM 8 may store an application program 105 for providing a variety of functionalities to a user. For instance, the application program 105 may comprise many types of programs such as a word processing application program, a spreadsheet application, a desktop publishing, and the like. According to an embodiment of the present invention, the application program 105 comprises a multiple functionality software application for providing a user calendaring functionality, electronic mail functionality, contacts information functionality, electronic notes functionality, electronic journal functionality and the like. Some of the individual program modules comprising the multiple functionality program 105 include a calendar module 125, an electronic mail program 130, a contacts module 135, a tasks module 140, a notes module 145 and a journal module (not shown). An example of such a multiple functionality program 105 is OUTLOOK® manufactured by Microsoft Corporation.

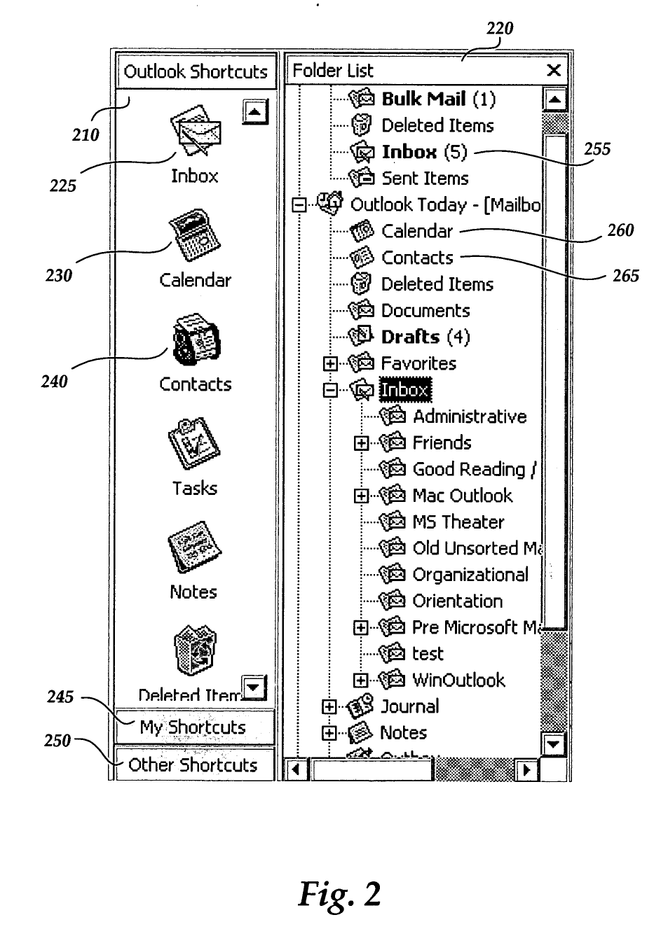

FIG. 2 illustrates a computer screen display of a prior content selection pane and a content display pane. According to the prior user interface system illustrated in FIG. 2, a module selection bar 210 is provided having a plurality of program module buttons 225, 230, 240 for selecting functionality associated with the identified program modules. Example modules include the inbox 225 associated with an electronic mail module, the calendar module 230 associated with an electronic calendar program module, and the contacts module 240 associated with an electronic contacts program module. To the right of the module selection bar 210 is a folder list 220, which according to prior systems, includes an outline form (e.g., tree view form) listing of selectable buttons and/or icons associated with functionality or memory locations associated with all available functionality of the combined functionality application 105. That is, the functionality or memory locations listed in the folder list 220 reference all functionality and memory locations associated with each of the selectable modules shown in the module selection bar 210.

For example, selection of the calendar module button 230 will launch the calendar module 125 of the multiple functionality application 105, and similarly, selection of the inbox module button 225 will launch the electronic mail module 130 of the multiple functionality application 105. However, according to the prior system illustrated in FIG. 2, the listing of functionality and memory locations in the folder list 220 does not change in response to selection of a particular program module such as the calendar module or the electronic mail module. That is, the list of functionality and memory locations contained in the folder list 220 is maintained as a list of all available functionality and memory locations under the multiple functionality application 105 regardless of the particular program module (e.g., electronic mail, calendar, contacts, etc.) in use at a given time. As is appreciated by those skilled in the art, the user may select a given program module functionality by selecting the appropriate button or icon from the folder list 220. For example, if the user desires to use her calendar application, rather than selecting the calendar module button 230 from the module bar 210, the user may likewise select the calendar button 260 from the folder list 220. As briefly described above, listing of all the available functionality and memory locations for all application modules available under the multiple functionality application is inefficient and is cumbersome where the user must peruse the entire list contained in the folder list 220 for particular functionality or memory locations of interest to the user even though the user may only be interested in functionality or memory locations associated with a particular application module such as the calendar module 125.

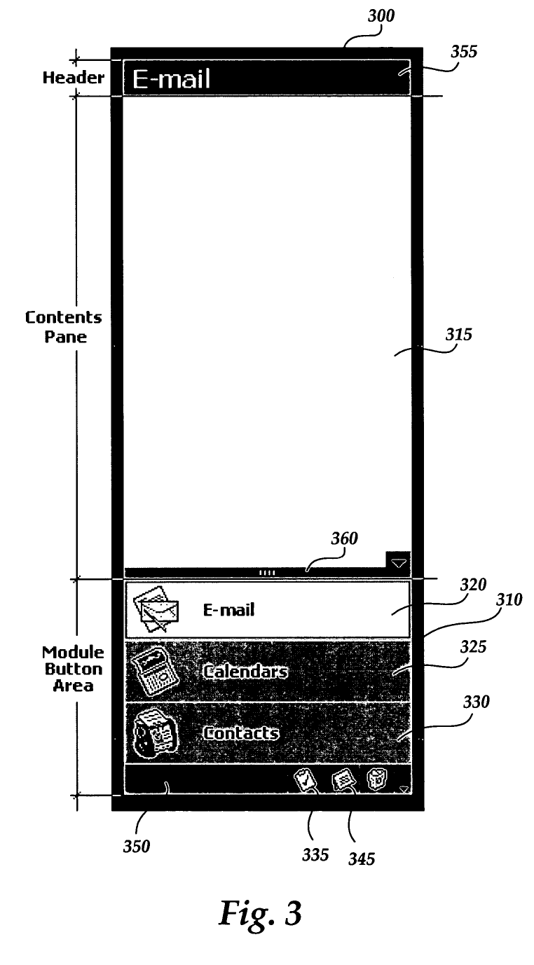

According to embodiments of the present invention, a combined content selection and display user interface or pane 300 is illustrated in FIG. 3. The combined content selection and display pane 300 includes a lower portion (program module button area) 310 and an upper portion (contents pane) 315. The lower portion 310 of the combined content selection and display pane 300 includes space for disposing selectable program module buttons 320, 325, 330 for selecting individual program modules available under a multiple functionality program 105. For example, as described above with reference to FIG. 1, the multiple functionality program 105 may include a calendar module 125, an electronic mail module 130, a contacts module 135, a tasks module 140, a notes module 145, and the like. Such a multiple functionality application allows the user to utilize each of the individual program modules via a single multiple functionality application 105. As should be appreciated by those skilled in the art, the individual program modules (e.g., electronic mail, calendars, contacts, etc.) described herein are for purposes of example only and are not limiting of the number and types of program modules that may be utilized in accordance with embodiments of the present invention.

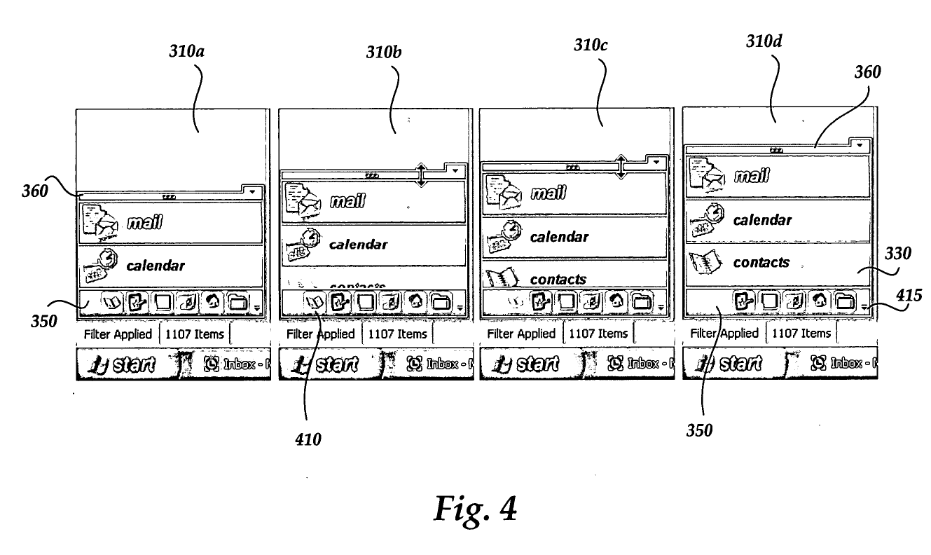

Referring still to FIG. 3, a function bar or tray 350 is disposed along the bottom edge of the program module button area 310. As will be described below with reference to FIG. 4, if the program module button area 310 lacks sufficient space for displaying a full size button 320, 325, 330 for an associated software module or functionality, a selectable icon 335, 345 may be displayed in the function bar or tray 350. For example, the selectable icon 335 may represent a tasks module 140. Accordingly, selection of the icon 335 from the function bar or tray 350 will cause a launching of the functionality associated with the tasks module 140 just as selection of the full size electronic mail button 320 causes a launching of the functionality associated with the electronic mail module 130. If the program module button area 310 is expanded, as described below, a full size module selection button may be displayed for the program modules represented by the selectable icons 335, 345 disposed in the function bar or tray 350. Likewise, if the size of the program module button area 310 is decreased, one or more of the full size buttons 325, 330 may be hidden from view, and an icon such as the icons 335, 345 may be displayed in the function bar 350 for selection of the associated functionality or software module.

As shown in FIG. 3, a splitter bar 360 is disposed between the program module button area (lower portion) 310 of the combined content selection and display pane 300 and the contents pane (upper portion) 315 of the combined content selection and display pane 300. As is described below with reference to FIG. 4, movement of the splitter bar 360 upward or downward causes the size of the program module button area 310 to increase or decrease according to user selection.

The contents pane 315 disposed in the upper portion of the combined content selection and display pane 300 provides space for displaying selectable buttons and/or icons associated with functionality and memory locations associated with or applicable to a program module selected from the program module button area 310. In contrast to the prior system described with reference to FIG. 2, only the functionality and memory locations associated with or applicable to a selected program module (e.g., electronic mail module 130) are displayed in the contents pane 315. Advantageously, the user is presented only with the functionality and memory locations associated with the program module (e.g., electronic mail) of interest to the user. Thus, the user does not have to peruse a listing of all functionality and memory locations associated with the multiple functionality application 105 where the user is only interested in a specific module such an electronic mail module, calendar module, contacts module, or the like.

As illustrated in FIG. 3, according to one embodiment of the present invention, a particular program module button, such as the electronic mail button 320, selected by the user may be color-coded or otherwise highlighted to distinguish the selected button from non-selected buttons. In addition, a header 325 identifying the program module selected by the user is defined along the upper portion of the combined content selection and display pane 300.

FIG. 4 illustrates a computer screen display of four different sizes of a lower portion of a content selection and display pane according to embodiments of the present invention. For purposes of illustrating the operation of the splitter bar 360, four different sizes of the program module button area 310 are illustrated in side-by-side orientation. As shown in the first view 310a, the splitter bar 360 is at a first position, which causes the program module button area to have space for only two full size program module buttons. The remaining functionality available under the associated multiple functionality application is illustrated by plurality of icons disposed in the functionality bar or tray 350 along the bottom of the program module button area 310a. Referring to the program module button area view 310b, a user may increase the size of the program module button area by dragging the splitter bar upward.

As illustrated in FIG. 4, dragging the splitter bar upward allows a third module button (e.g., contacts module button) to be displayed in the program module button area. According to an embodiment of the present invention, and as illustrated in FIG. 4, until sufficient space has been added to the program module button area 310 to allow a new module button to be fully displayed in the program module button area 310, the icon representing that program module button remains displayed in the functionality bar 350. Referring to the fourth view of the program module button area 310d, once the splitter bar 360 is moved upward to allow sufficient space for fully displaying the new program module button 330, the associated icon 410 displayed in the functionality bar or tray 350 is removed.

Referring still to FIG. 4, as illustrated in the program module button area view 310d, a selectable icon 415 (e.g., chevron) is disposed in the functionality bar or tray 350. As should be appreciated, the program module button area 310 may be reduced to such a point that the functionality bar or tray 350 will not contain enough space for an icon representative of each program module previously represented by a button in the program module button area 310. In such cases, some of the icons 410 may be hidden from view. According to embodiments of the present invention, selection of the icon 415 may display a text box to the user to provide the user selectable buttons or icons for selecting program modules that are no longer represented by a button 320, 325, 330 in the program module button area 310 or by an icon 410 in the functionality bar or tray 350.

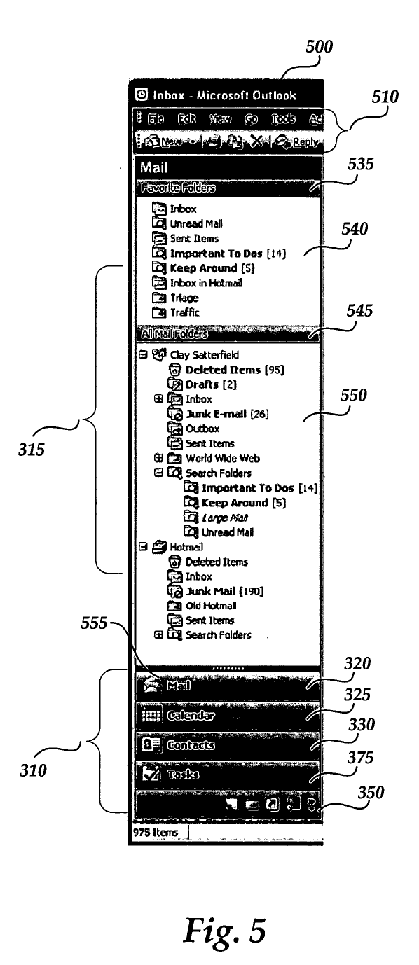

FIG. 5 illustrates a computer screen display of a combined content selection and display pane showing display of electronic mail program functionality and associated memory locations in the upper portion of the pane. FIG. 5 illustrates operation of the combined content selection and display user interface of the present invention in conjunction with a user interface 500 of a given multiple functionality application 105 as described above with reference to FIG. 1. The user interface 500 includes a plurality of selectable function buttons 510 for operation of the overall multiple functionality application 105. The combined content selection and display pane of the present invention is displayed within the user interface 500. The program module button area 310 is illustrated along a lower portion of the pane and the contents pane 315 is illustrated along an upper portion of the pane. As described above, selection of one of the particular program module buttons 320, 325, 330, 375 from the program module button area 310 causes a display of selectable buttons and/or icons associated with additional functionality or memory locations applicable to the selected module. According to the screen display illustrated in FIG. 5, the electronic mail module button 320 has been selected by the user. As described above, the selected module button may be color-coded or otherwise highlighted to identify the selected module. For example, as illustrated in FIG. 5, the envelope icon 555 is illustrated in an open configuration to identify that the mail module button 320 has been selected.

Referring to the contents pane 315, selection of the mail module button 320 causes a display in the contents pane 315 of selectable buttons and/or icons associated with only those functionality or memory locations associated with the selected mail program module. That is, selection of the mail module button 320 provides the user functionality and memory location information for the electronic mail module 130, but does not provide the user functionality or memory locations for any other available software module. As illustrated in FIG. 5, the items displayed in the contents pane 315 may be divided among one or more categories. For example, a “Favorite Folders” category 535 is illustrated for containing particular electronic mail folders of interest to the user. An “All Mail Folders” category 545 is illustrated for containing selectable buttons and/or icons for all functionality or memory locations associated with the electronic mail module 130. As should be appreciated by those skilled in the art, a user may readily add additional folders to the “Favorite Folders” category 535 by dragging a desired folder from the “All Mail Folders” section 545 into the “Favorite Folders” section 535.

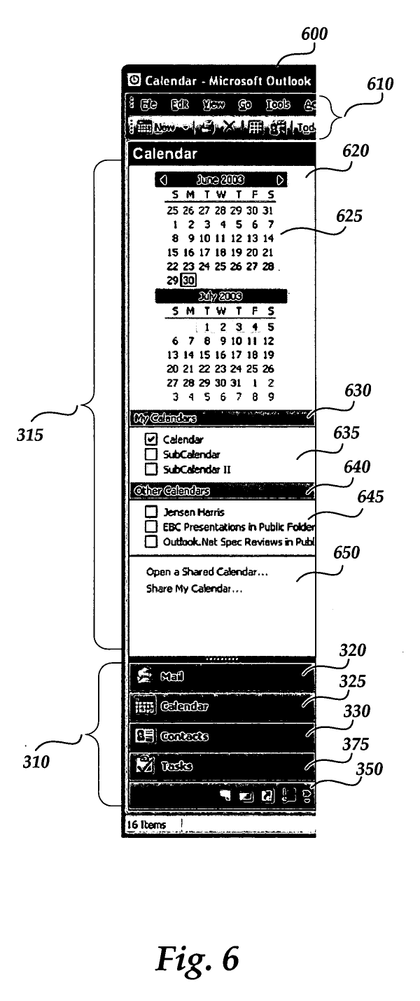

FIG. 6 illustrates a computer screen display showing display of calendar program module functionality in the upper portion of the combined content selection and display pane. A user interface 600 associated with a calendar program module 125 is illustrated. Selectable functionality buttons 600 are illustrated for selection of general functionality associated with the calendar program module 125. The combined content selection and display pane of the present invention is disposed within the user interface 600. As illustrated in FIG. 6, the calendar program module button 325 has been selected by a user. Selectable buttons and/or icons associated with the calendar program module 125 are displayed in the contents pane 315. For instance, date picker controls 620 (e.g., June 2003, July 2003) are displayed to allow the user to select or display in the user interface 600 a calendar associated with a selected day 625. As is well known to those skilled in the art, selection of a particular day from the date picker controls 620 may cause a calendar for the selected date to be displayed to the user in the user interface 600 to allow the user to review, add, delete, or otherwise modify data such as scheduled appointments in the selected calendar.

As illustrated in FIG. 6, the contents pane 315 may include other categories of calendar information including the “My Calendars” section 630 for including one or more selectable calendars associated with the user of the user interface 600. According to embodiments of the present invention, the date picker controls 620 will provide access to data for a selected calendar. An “Other Calendars” section 640 is illustrated for containing other calendars of interest to the user. As should be appreciated, calendars may be added to or deleted from the “My Calendars” section 630 or the “Other Calendars” section 640 upon user selection. Another functionality section 650 is illustrated for containing other functionality available to the user under the calendar program module 125. Importantly, only functionality or information associated with the calendar program module 125 is displayed to the user in the contents pane 315 upon selection of the calendar program module button 325 from the program module button area 310. Functionality or information associated with any of the other available program modules (e.g., electronic mail, contacts, etc.) is not displayed in the contents pane 315.

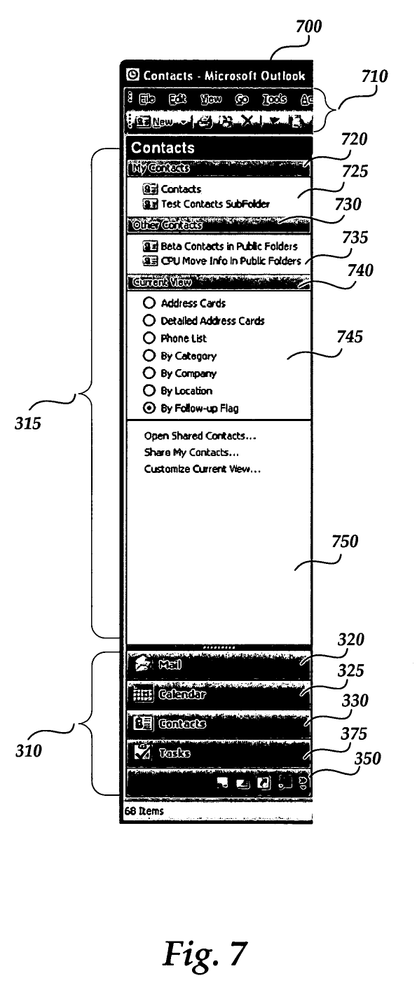

FIG. 7 illustrates a computer screen display showing contacts program module functionality displayed in the upper portion of the combined content selection and display pane. The user interface 700 is illustrated for the contacts program module 135 of the multiple functionality application 105 described above with reference to FIG. 1. Selectable functionality buttons 710 for providing general functionality of the contacts program module 135 are illustrated at the upper portion of user interface 700. As illustrated in FIG. 7, the contacts program module button 330 has been selected from the program module button area 310 for displaying selectable buttons and/or icons in the contents pane 315 associated with or applicable to functionality or memory locations associated with the contacts program module 135. A “My Contacts” section 720 is defined along an upper portion of the contents pane 315 for containing particular contacts information 725 of interest to the user. An “Other Contacts” section 730 is provided for displaying additional contacts information 735. A “Current View” section 740 is displayed for allowing a user to select the manner in which contacts information is displayed by the user interface 700. As is well known to those skilled in the art, selection of one of the radio buttons 745 illustrated in the “Current View” section 740 will provide the user a desired contacts information view type.

An additional functionality section 750 is illustrated for providing the user other functionality available to the user via the contacts program module 135. For example, a “Share My Contacts” function is illustrated in FIG. 7 for allowing the user to selectively share contacts information with a different user via a distributed computing environment. Importantly, only functionality and information associated with or otherwise applicable to the contacts program module 135 is displayed to the user in the contents pane 135 upon selection of the contacts program module button 330.

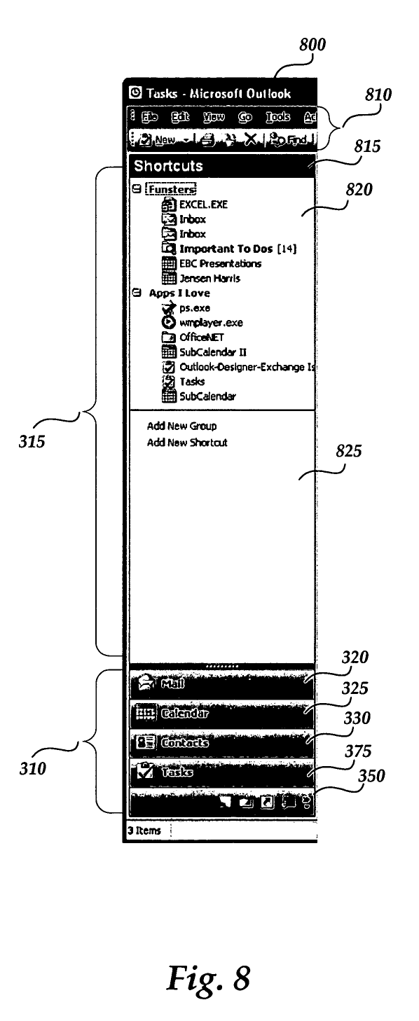

FIG. 8 illustrates a computer screen display showing shortcuts functionality displayed in the upper portion of the combined content selection and display pane. A user interface 800 is illustrated for providing the user functionality associated with the tasks module 140. A plurality of selectable functionality buttons 810 is illustrated for providing general functionality associated with the tasks module 140. As illustrated in FIG. 8, a shortcuts icon from the functionality bar or tray 350 has been selected for providing selectable buttons and/or icons associated with a user's shortcuts list in the contents pane 315. A plurality of shortcuts to applications, program modules, or memory locations of interest to the user are displayed in the upper section 820 of the contents pane 315. A lower section 825 is displayed for providing additional shortcuts functionality to the user. For example, the “Add New Shortcut” function may be used for adding an additional shortcut to a desired software application or memory location to the upper section 820. As described similarly for FIGS. 5-7 above, only functionality and/or memory locations associated with or otherwise applicable to the selected shortcuts function selected by the user are displayed in the contents pane 315. Functionality or information associated with other software modules, (e.g., electronic mail, calendar, contacts, etc.) are not displayed in the contents pane 315.

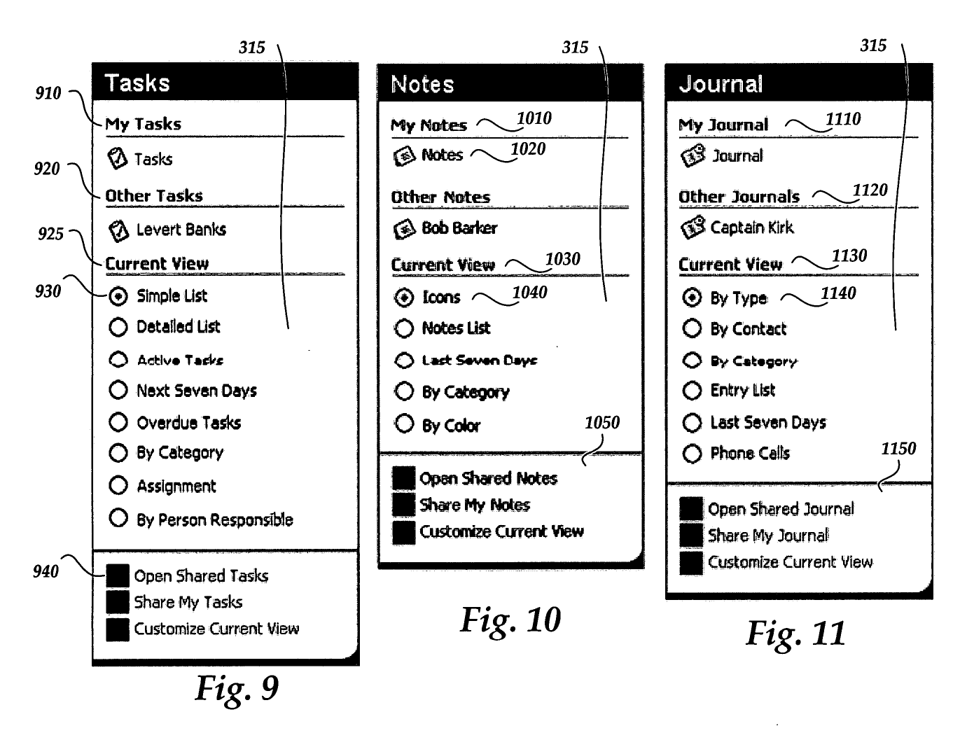

FIG. 9 illustrates a computer screen display of the contents pane 315 of the combined content selection and display pane 300 where the contents pane 315 has been populated with selectable buttons and/or icons associated with functionality of the tasks module 140 described above with reference to FIG. 1. As should be appreciated from the description of FIGS. 5-8 above, population of the contents pane 315, as illustrated in FIG. 9, is in response to selection of a tasks module button 375 from the program module button area 310, or in response to selection of a tasks module icon 410 from the function bar 350. The contents pane 315 for the tasks module 140 may include a “My Tasks” section 910 for including personal tasks entered specific to a given user. An “Other Tasks” section 920 may be included for identifying other tasks of interest to the user. As should be appreciated, selection of any of the tasks buttons or icons in the pane 315 causes a multiple functionality application 105 to launch a user interface for the tasks module 140 for displaying the selected tasks. A “Current View” section 925 includes a plurality of radio buttons 930 for allowing a user to select a view type for a selected task. An additional functionality section 940 is included for allowing the user to invoke other functionality of the tasks module 140 such as sharing tasks information with a separate user via a distributed computing environment. As with the other example embodiments described above, only functionality and memory locations associated with the tasks module 140 are displayed in the contents pane 315 in response to user selection of a tasks button or icon from the program module button area 310.

FIG. 10 illustrates a computer screen display of a contents pane 315 for displaying functionality and memory locations associated with a notes program module 145 described above with reference to FIG. 1. As shown in FIG. 10, a “My Notes” section 1010 is provided for including a selectable button or icon for launching information associated with user specific notes. An “Other Notes” section 1020 is provided for accessing notes associated with other users. A “Current View” section 1030 is included for providing a plurality of radio buttons 1040 for allowing a user to select a view type for displayed notes. An additional functionality section 1050 is provided for allowing the user to invoke other functionality of the notes program module 145 such as sharing the user's notes with another user via a distributed computing environment.

FIG. 11 illustrates a computer screen display of a contents pane 315 populated with selectable buttons and/or icons associated with the functionality of a journal program module operating via the multiple functionality application 105. A “My Journal” section 1110 is provided for allowing a user selectable access to the user's personal journal entries. An “Other Journals” section 1120 is provided for allowing the user selectable access to other journal entries. A “Current View” section 1130 is provided for providing the user a plurality of radio buttons 1140 for selecting a view type for displayed journal entries. An additional functionality section 1150 is provided for allowing the user to select other functionality associated with the journal program module such as sharing the user's journal entries with a different user through a distributed computing environment.

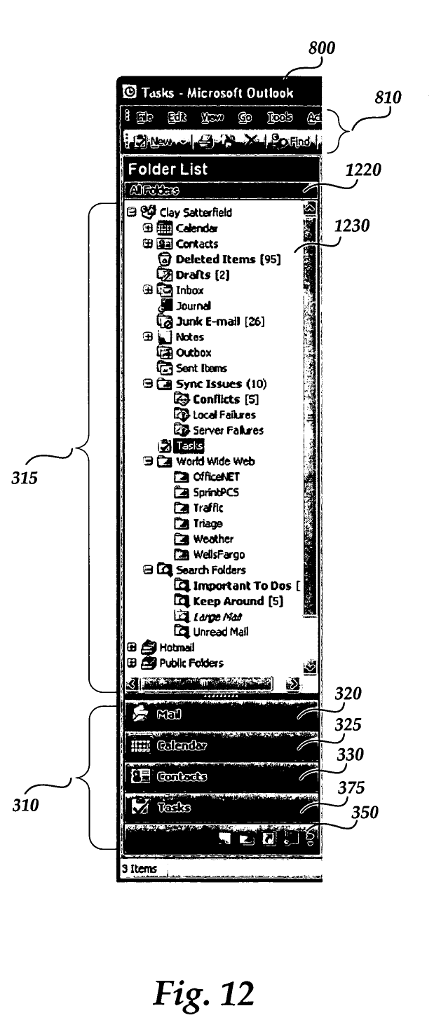

FIG. 12 shows a computer screen display illustrating a folder list for displaying all functionality in the upper portion of the combined content selection and display pane associated with all functionality provided by an associated multiple functionality application. According to embodiments of the present invention, a folder list 1230 may be selectively launched into the contents pane 315 of a user interface of the multiple functionality application 105. For example, referring to FIG. 12, a user interface 800 associated with the tasks module 140 has been launched by the user. By selecting a folder list button or icon (not illustrated), the user may selectively populate the contents pane 315 with selectable buttons and/or icons associated with all functionality and/or memory locations associated with all program modules available under the multiple functionality application 105. That is, functionality and memory locations associated with all selectable program modules (e.g., electronic mail, calendar, contacts, tasks, notes, journals, etc.) are populated into the contents pane 315 as if all available program modules are simultaneously selected. As should be appreciated, the contents pane 315 illustrated in FIG. 12 may be divided into a plurality of categories such as the “All Folders” category 1220. Other categories such as “My Folders” category (not illustrated) may also be provided.

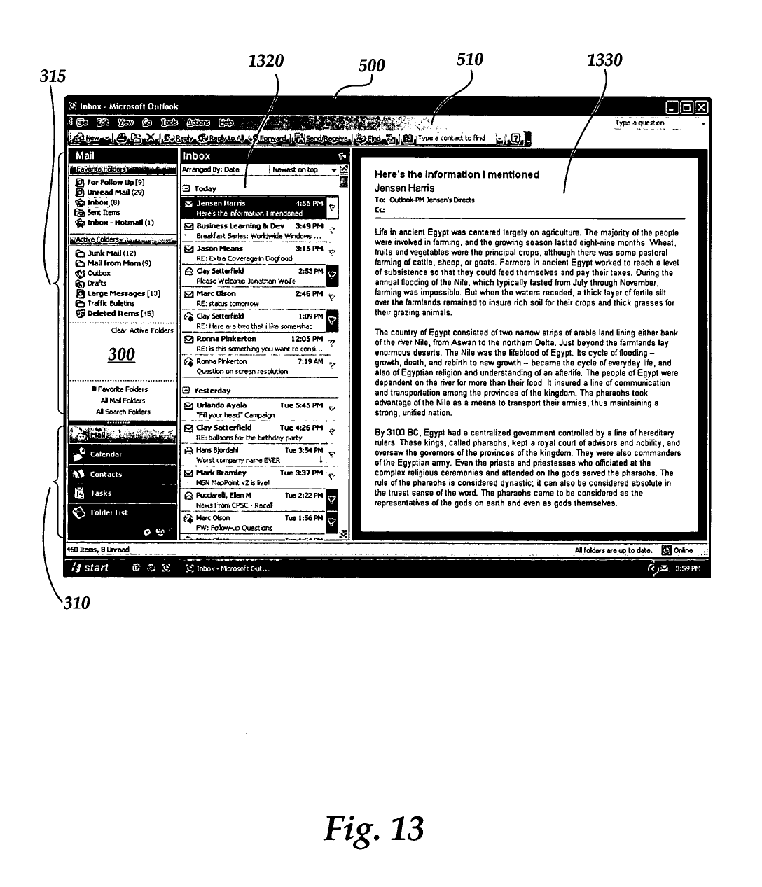

FIG. 13 illustrates a computer screen display of a multiple functionality software application showing a combined content display and selection pane according to embodiments of the present invention. The user interface 500 illustrated above with respect to FIG. 5, is shown in an expanded view for purposes of illustrating the relationship between the combined content selection and display pane 300 with other user interface components of the overall user interface 500. As should be appreciated, the example electronic mail inbox user interface 500 illustrated in FIG. 13 is for purposes of example only and is not limiting of the invention as claimed herein.

Referring to FIG. 13, the combined content selection and display pane 300 is disposed along the left side of the user interface 500. As described above, the contents pane 315 of the combined contents selection and display pane 300 has been populated with selectable buttons and/or icons associated with functionality and memory locations associated with the electronic mail module 130 in response to user selection of the mail module button 320 from the program module button area 310. In response to selecting the “Inbox” button or icon from the contents pane 315, the user's electronic mail inbox 1320 is displayed via the user interface 500. Additionally, because the user has selected that a preview of selected electronic mail entries be displayed to the user, a preview pane 1330 is displayed for providing a preview of information contained in a selected electronic mail entry. Operation of electronic mail systems, such as illustrated and described with reference to FIG. 13, are well known to those skilled in the art.

According to embodiments of the present invention, if the user selects a different functionality button and/or icon such as the “Sent Items” button from the contents pane 315, the Inbox user interface component 1320 is dynamically changed to include information for Sent Items. Likewise, selection of any of the other available functionality buttons and/or icons from the contents pane 315 will launch the appropriate user interface components associated with the selected functionality button or icon. If the user next selects a different program module button from the program module button area 310, for example the calendar module button, the contents pane 315 will be immediately populated with selectable buttons and/or icons associated with functionality and memory locations for the newly selected program module.

According to an embodiment of the invention, the last selected functionality from the contents pane 315 during the user's last selection of a given program module (e.g., calendar module) will be displayed by the user interface for the multiple functionality application 105. For example, if during the user's last selection and use of the calendar module the user selected a particular calendar date for review, that same calendar date may be displayed by the user interface 500 upon the user's next selection of the calendar module button. Alternatively, a default display may be set up where, for example, the current calendar day view is always displayed upon selection of the calendar module button. Continuing with the example illustrated in FIG. 13, if the user next returns back to the electronic mail module by selecting the mail module button 320, the contents pane 315 is once again populated with functionality and memory locations for the electronic mail module, and the electronic mail module information displayed by the user during the user's last selection of the electronic mail module is once again displayed to the user in the user interface components 1320 and 1330. Alternatively, a default display may prescribed such that a default display of current Inbox contents are always displayed to the user upon selection of the electronic mail module button 320.

As described herein, a combined content selection and display user interface or pane is provided for displaying to a user selectable buttons and/or icons associated with functionality or memory locations associated with or applicable to a selected program module of a multiple functionality software application. It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

1. In a multiple functionality software application, a combined content selection and display user interface, comprising:
a lower portion containing one or more program module buttons for selecting one or more program modules from a plurality of available program modules from the multiple functionality software application; and
an upper portion defining a contents display pane for displaying available functionality associated with a selected program module button.

2. The user interface of claim 1, whereby the one or more program module buttons are operatively associated with one or more respective program modules such that selection of a particular program module button causes the contents pane to be populated with the available functionality associated with the selected program module button.

3. The user interface of claim 2 whereby the contents pane is operative to display one or more selectable functionality buttons associated with a particular program module upon selection of a program module button associated with the particular program module.

4. The user interface of claim 3, whereby selection of one of the one or more selectable functionality buttons causes the multiple functionality software application to provide a particular functionality associated with the selected functionality button.

5. The user interface of claim 1, further comprising a functionality tray defined along a lower end of the lower portion of the user interface for displaying one or more program module icons.

6. The user interface of claim 5, further comprising a splitter bar disposed between the lower portion of the user interface and the upper portion of the user interface for separating the lower portion from the upper portion.

7. The user interface of claim 6, whereby the splitter bar is movable for increasing or decreasing a size of the lower portion of the user interface and for increasing or decreasing a size of the upper portion of the user interface.

8. The user interface of claim 7, whereby the one or more program module icons are associated with one or more program modules, and whereby a given program module icon is disposed in the functionality tray when the lower portion of the user interface lacks sufficient space for displaying a program module button for a program module associated with the given program module icon.

9. The user interface of claim 8, whereby the one or more program module icons are operatively associated with one or more respective program modules such that selection of a particular program module icon causes the contents pane to be populated with the available functionality of a particular program module associated with the selected program module icon.

10. The user interface of claim 9, whereby the lower portion of the user interface is operative to display one or more additional program module buttons associated with one or more program module icons when the size of the lower portion of the user interface is increased to a size sufficient for displaying the one or more additional program module buttons.

11. The user interface of claim 10, whereby the lower portion of the user interface is further operative to remove a particular program module icon from the functionality tray when a program module button for a program module associated with the particular program module icon is added to the lower portion of the user interface.

12. The user interface of claim 11, whereby the functionality tray is operative to display an additional program module icon for a particular program module where the size of the lower portion of the user interface is decreased such that a program module button associated with the particular program module will not fit in the lower portion of the user interface.

13. The user interface of claim 1, whereby the one or more program module buttons are highlighted upon selection for identifying a selected program module button.

14. The user interface of claim 13, whereby the highlighted one or more program module buttons is color-coded.

15. The user interface of claim 1, whereby one of the one or more program modules is an electronic mail program module.

16. The user interface of claim 15, whereby displayed available functionality associated with the selected program module includes displayed available functionality associated with the electronic mail program module.

17. The user interface of claim 1, whereby one of the one or more program modules is an electronic calendar program module.

18. The user interface of claim 17, whereby displayed available functionality associated with the selected program module includes displayed available functionality associated with the electronic calendar program module.

19. The user interface of claim 1, whereby one of the one or more program modules is an electronic contacts program module.

20. The user interface of claim 19, whereby displayed available functionality associated with the selected program module includes displayed available functionality associated with the electronic contacts program module.

21. The user interface of claim 1, whereby one of the one or more program modules is an electronic tasks program module.

22. The user interface of claim 21, whereby displayed available functionality associated with the selected program module includes displayed available functionality associated with the electronic tasks program module.

23. The user interface of claim 1, whereby one of the one or more program modules is an electronic notes program module.

24. The user interface of claim 23, whereby displayed available functionality associated with the selected program module includes displayed available functionality associated with the electronic notes program module.

25. The user interface of claim 1, whereby one of the one or more program modules is an electronic journal program module.

26. The user interface of claim 25, whereby displayed available functionality associated with the selected program module includes displayed available functionality associated with the electronic journal program module.

27. The user interface of claim 1, whereby one of the one or more program modules is an electronic shortcuts function.

28. The user interface of claim 27, whereby displayed available functionality associated with the selected program module includes displayed one or more shortcuts comprising the shortcuts program module.

29. The user interface of claim 1, whereby one of the one or more program modules is an electronic folder list.

30. The user interface of claim 29, whereby displayed available functionality associated with the selected program module includes displayed available functionality and memory locations associated with each of the one or more program modules.

31. In a multiple functionality software application, a combined content selection and display user interface, comprising:
a program module button area disposed in a lower portion of the user interface containing one or more program module buttons for selecting one or more program modules from a plurality of available program modules from the multiple functionality software application;
a contents pane disposed in an upper portion of the user interface for displaying available functionality associated with a selected program module button; and
whereby the one or more program module buttons are operatively associated with the one or more program modules such that selection of a particular program module button causes the contents pane to be populated with the available functionality associated with the selected program module button.

32. The user interface of claim 31, further comprising a functionality tray defined along a lower end of the program module button area for displaying one or more program module icons.

33. The user interface of claim 32, further comprising a splitter bar disposed between the program module button area and the contents pane for separating the program module button area from the contents pane.

34. The user interface of claim 33, whereby the splitter bar is movable for increasing or decreasing a size of the program module button area and for increasing or decreasing a size of the contents pane.

35. The user interface of claim 34, whereby the one or more program module icons are associated with one or more program modules, and whereby a given program module icon is disposed in the functionality tray when the program module button area lacks sufficient space for displaying a program module button for a program module associated with the given program module icon.

36. In a multiple functionality software application, a combined content selection and display user interface, comprising:
a program module button area disposed in a lower portion of the user interface containing one or more program module buttons for selecting one or more program modules from a plurality of available program modules from the multiple functionality software application;
a contents pane disposed in an upper portion of the user interface for displaying available functionality associated with a selected program module button;
a splitter bar disposed between the program module button area and the contents pane for separating the program module button area from the contents pane; and
whereby the one or more program module buttons are operatively associated with the one or more program modules such that selection of a particular program module button causes the contents pane to be populated with the available functionality associated with the selected program module button.

37. The user interface of claim 36, whereby the splitter bar is movable for increasing or decreasing a size of the program module button area and for increasing or decreasing a size of the contents pane.

38. The user interface of claim 37, further comprising a functionality tray defined along a lower end of the program module button area for displaying one or more program module icons whereby the one or more program module icons are associated with one or more program modules, and whereby a given program module icon is disposed in the functionality tray when the program module button area lacks sufficient space for displaying a program module button for a program module associated with the given program module icon.
